(19) United States
(12) Patent Application Publication
(10) Pub. No.: US 2004/0197609 A1
(43) Pub. Date: Oct. 7, 2004

(54) Fuel cells employing nanostructures

(76) Inventor: Anthony D. Kurtz, Ridgewood, NJ (US)

Correspondence Address: DUANE MORRIS LLP, 100 COLLEGE ROAD WEST, SUITE 100, PRINCETON, NJ, 08540-6604, US

(21) Appl. No.: 10/405,267

(22) Filed: Apr. 2, 2003

(51) Int. Cl. H01M 8/00

(52) U.S. Cl. 429/12

(57) ABSTRACT

A solid state fuel cell is fabricated from three substructures. There is a nanostructure porous semiconductor anode which is surrounded by a non-porous ring. The pore size of the anode material is sufficiently large to allow hydrogen gas to flow through and is of a sufficiently high conductivity to easily permit current flow of electrons. One side of the anode has a layer of titanium and platinum catalyst sputtered or otherwise deposited on the surface with the pores to produce a coated surface with the catalyst entering and coating the walls of the pores. A cathode is made in a similar manner and is fabricated as is the anode. There is a center electrolytic section made from a low conductivity semiconductor material. The center electrolytic section has the coated side of the anode secured to one side and has the coated side of the cathode secured to the other side. The other or un-coated face of both the anode and the cathode has an electrical contact secured thereto to permit electrons to leave the anode and to reenter the cathode. The electrolytic center structure is filled with an ionic conductor. In this manner, hydrogen is broken into ions and electrons. The electrons cause a current flow, while the ions react with oxygen and produce water which is discharged from the fuel cell as steam or vapor.

### FIELD OF INVENTION

This invention relates to a fuel cell structure and more particularly to a fuel cell made from structures employing semiconductors and other materials.

### RELATED APPLICATIONS

The subject matter of this application is also pertinent to U.S. Ser. No. 10/085,387 filed on Feb. 28, 2002 and entitled, “Solid State Fuel Cells” having attorney docket number Kulite-71. See also Kulite-87 entitled, “Nanotube Semiconductor Structures with Varying Electrical Properties” filed on Mar. 25, 2003.

### BACKGROUND OF THE INVENTION

Like the conventional dry cell and lead acid batteries, fuel cells work by virtue of electrochemical reactions in which the molecular energy of the fuel and an oxidant are transformed into direct current electrical energy. Fuel cells do not consume chemicals that form part of their structure or as stored within a structure. They react with fuels supplied from outside the cell. Since the fuel cell itself does not undergo an irreversible chemical change, it can continue to operate as long as its fuel and oxidant are supplied and byproducts removed, or at least until electrodes cease to operate because of mechanical or chemical deterioration.

A fuel cell basically consists of a container of an electrolyte. For example, the electrolyte can be a water solution of an acid, such as phosphoric acid, or a similar acid. In this solution are immersed two porous electrodes and through these the reactants, as hydrogen and oxygen, are brought into contact with the electrolyte. The hydrogen and oxygen react to release ions and electrons, and water is produced. The electrons are made to do useful work in an external circuit, whereas the ions flow from one electrode to the other to complete the internal circuit in the cell. The operation of fuel cells is very well understood. See, for example, a publication by NASA entitled, “Fuel Cells—A Survey”, NASA SP-5115 published in 1973. Every fuel cell uses an input fuel which is catalytically reacted (electrons removed from the fuel elements) in the fuel cell to create an electric current. Every fuel cell consists of an electrolyte material which is sandwiched between two porous electrodes as the anode and cathode. The input fuel passes through the anode (oxygen through the cathode) where it is split into ions and electrons. The electrons go through an external circuit while the ions move through the electrolyte to the oppositely charged cathode. At the cathode, the ions combine with oxygen to form H₂O and depending on the fuel, carbon dioxide (CO₂).

Thus, at the anode H₂→2H³⁰ +2e⁻

and at the cathode

$$\frac{1}{2} {O}_{2} + 2 {H}^{+} + 2 {e}^{-} \to {H}_{2} O$$

O₂+2H⁺+2e⁻→H₂O

In most fuel cells platinum, which coats both the anode and cathode, the side adjacent to the electrolyte serves as a catalyst for the oxidation and reduction processes. Fuel and oxidant gases are supplied to the back of the anode and the cathode respectively, and both the anode and cathode are electrically conductive. Fuel is supplied to the backside of the anode and oxygen is supplied to the backside of the cathode. In addition, both on the anode and on the cathode side there is an exit hole to permit the egress of either fuel or extra oxygen and on the cathode side (the reaction byproducts), as water (as steam) and/or carbon dioxide CO₂. Thus, fuel cells are very well known and operation is continued to be improved. See, for example, an article in Popular Science, March 2002, Volume 260, No. 3, page 61 entitled, “Dreams of the New Power—A Fuel Cell in Every Home”. That article describes the problems with fuel cells, as well as the operation of fuel cells and the attempt to reduce the costs of fuel cells.

It is therefore an object of the present invention to provide an improved fuel cell which employs nanostructures tubes and fuel cells exhibit improved operation.

### SUMMARY OF INVENTION

A solid state fuel cell comprises a nano-anode structure of a given conductivity which has a plurality of pores each of a given diameter directed from a first surface to a second surface, with the first surface coated with a metallic catalyst. A nanocathode structure of a given conductivity has a plurality of pores each of a predetermined diameter directed from a first surface to a second surface, with the first surface coated with a metallic catalyst. An electrolyte planar structure has a plurality of pores directed from a first surface to a second surface, with the metallized surface of the anode structure coupled to the first surface of the electrolyte structure with the metallized surface of the cathode structure coupled to the second surface of the electrolyte structure.

### BRIEF DESCRIPTION OF THE FIGURES

FIG. 1 is a perspective view of a nanostructure, which is employed as an anode or cathode according to this invention

FIG. 2 consists of a cross sectional view of an anode or cathode porous nanostructure utilized in conjunction with this invention.

FIG. 3 is a front view of an electrolyte structure used in this invention.

FIG. 4 shows an assembled fuel cell and circuit operating with a load to provide a current through the load upon fuel cell operation according to this invention.

### DETAILED DESCRIPTION OF THE FIGURES

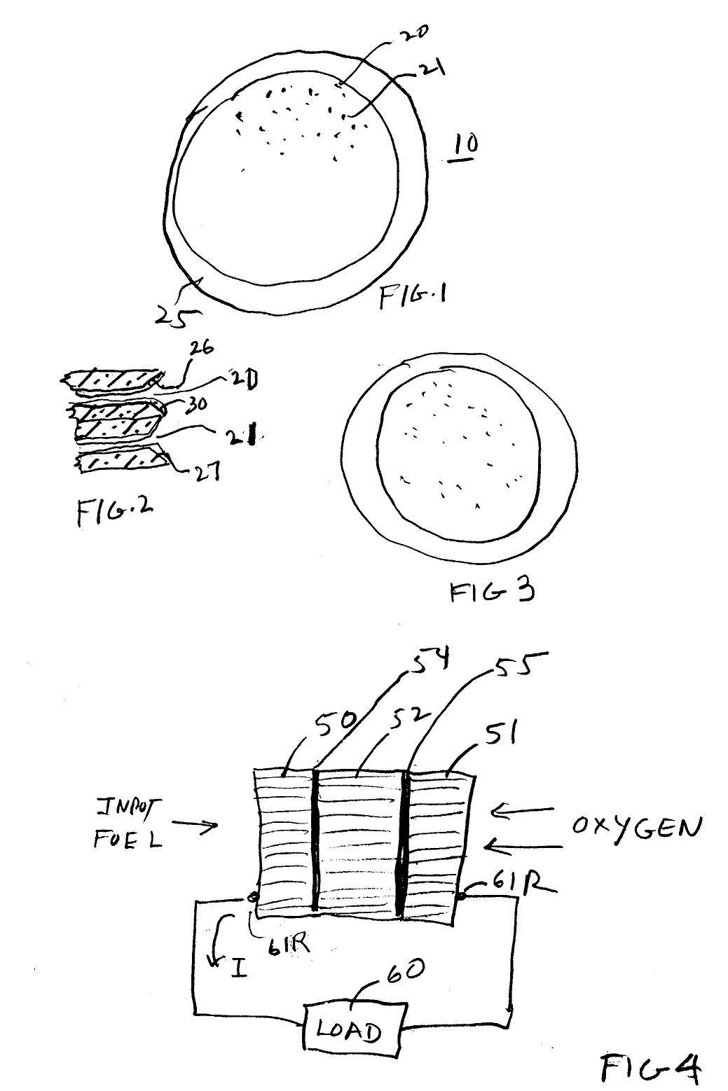

Referring to FIG. 1, there is shown a nanostructure 10. Essentially, the nanostructure is fabricated from silicon, silicon carbide, but as will be explained, other materials can be used and can mimic the effects of nanostructures.

In the above-noted application, namely, Ser. No. 10/085,387 filed Feb. 28, 2002, there is claimed and described a solid state fuel cell. This fuel cell utilizes porous materials, as are utilized in the present invention. The porous materials utilized are relatively enlarge pores and are not considered to be nanopores or nanostructures, as in this invention. In this invention, we are talking about pores having diameters in the nanometer range, which are extremely small pores and essentially considered to be nanopores. Porous silicon has been used for many years for manufacturing of micromechanical devices. Porous silicon is formed on a silicon substrate during anodization and the hydrofluoric acid electrolyte.

Based on control of the material, one can form macropores or micropores. In other words, the micropore or nanopore would be extremely small, as for example, average dimensions below 2 nanometers. These micropores are dominated by quantum size effect. It is well-known how to form micropores on both silicon and silicon carbide. For example, see an article entitled, “Porous Silicon—a New Material for MEMS by V. Lehmann published in the 1996 proceedings of the IEEE. This article describes and shows various techniques performing porous silicon. It is also known to form porous silicon carbide.

It is interesting to note in the above-noted articles, both macropores and micropores are formed. It is a desire of the present invention to utilize microporous structures, which structures have quantum size effects and produce unanticipated operation. This is due to size and because quantum physics controls operation at the nanometer scale, such nanostructures perform unique electronic devices at an extremely high efficiency.

It has long been known that a plurality of nanocrystallites and silicon carbide (SiC) would give rise to an enlargement of the energy gap of the SiC shifting any emitted light, for example, towards the UV region because of quantum confinement. This allows a relaxation of momentum selection rules by confining the charge carry spatially, thus allowing direct band gap. For example, see Kulite-87 entitled, “Nanotube Semiconductor Structures with Varying Electrical Properties” which application is co-pending herewith and which application is assigned to Kulite Semiconductor Products, Inc., the assignee herein. In that patent application there is described various patents also assigned to Kulite which specify the fabrication of porous SiC. See for example, U.S. Pat. No. 5,376,241 entitled, “Fabricating Porous Silicon Carbide” by A. D. Kurtz et al., which issued on Dec. 27, 1994 and is assigned to the assignee herein.

See also U.S. Pat. No. 5,376,818 entitled, “Large Area P—N Junction Devices Formed from Porous Silicon” which issued on Dec. 27, 1994 to A. D. Kurtz et al. and assigned to the assignee herein. See also U.S. Pat. No. 5,834,378 entitled, “Passivation of Porous Semiconductors for Improved Opto-Electronic Device Performance in Fabrication of Light Emitting Diodes Based on Same”. The patent issued on Nov. 10, 1998 to A. D. Kurtz and is assigned to the assignee herein. See also U.S. Pat. No. 5,939,732 which issued on Aug. 7, 1999 entitled, “Vertical Cavity Emitting Porous Silicon Carbide Light Emitting Diode Device and Preparation Thereof”. This patent is also assigned to the assignee herein and is invented by A. D. Kurtz et al.

The above patents show that the porous nanocrystallites in SiC give rise to an enlargement of the energy gap and shifts emitted light towards the UV region.

Therefore, it is an object of the present invention to provide an improved fuel cell using porous nanostructures fabricated from silicon, as well as other materials.

Referring to FIG. 1, there is shown an anode or cathode electrode for a fuel cell, which has disposed on a surface a plurality of nanopores, such as, for example, 21, 22 and so on. It is noted that these nanostructures are disposed throughout the entire surface of the substrate 20. In this manner, it is also known that a substrate 20, as indicated in the above-noted pending application can be fabricated from different structures. The substrate 20 can be silicon, silicon carbide, graphite or some other suitable material in which nanopores can be formed.

One can surround the substrate 20 by a ring of material, which is a non-porous ring such as 25. The non-porous ring can be fabricated from many different structures, including metals or other materials. The surface of the substrate may be covered by a layer of titanium-platinum. The thickness of the sputtered layer of titanium-platinum is on the order of 2000 to 4000 Angstroms. See the above-noted pending application. Essentially, the surface is sputtered with titanium-platinum which covers the surface containing the pores. The cathode is also formed exactly as the anode, as shown in FIG. 1, and the cathode, for example, will also have a series of apertures as 21 and 22 dispersed along the surface 20. The cathode also may be surrounded by a non-porous ring.

As seen in FIG. 2, there is shown a cross-sectional view of pores, for example, 20 and 21. As one can ascertain from FIG. 2, the pores preferably have a larger front opening and are tapered to a smaller channel. The pores are covered with a layer of titanium-platinum which is sputtered on the opening of the pore and inside the channel. The metal layer is designated by reference numerals 30 and 26. The titanium-platinum is sputtered or otherwise deposited on the surface and is done in extremely low orders of thicknesses of between 500 to 2000 Angstroms. The surface is sputtered with titanium-platinum which covers the surface containing the pores and covers the inside of the tubes as well. Thus, as shown in FIG. 2, each pore has a large opening which is coated with metal, as is the inside of the pores. The pores are extremely small, but are large enough to allow oxygen or hydrogen to diffuse therethrough.

FIG. 3 depicts an electrolyte section 30. The electrolyte section can be made from silicon and has a non-porous ring 32 surrounding the same. The electrolyte section is made from a low conductivity silicon or silicon carbide and has a much smaller pore size than the pore size of the anode or cathode. The conductivity of the electrolyte section is substantially less (ten times) than the conductivity of the cathode or anode. The pores in the electrolyte section 30 are approximately one quarter to one half or smaller than the size of the pores in the anode or cathode.

If one addresses the above-noted patent application entitled, “Solid State Fuel Cell”, one can obtain more information about the size of the pores and especially about the fabrication of the cell. The pores, as indicated, and the face of the wafer shown in FIG. 1 are coated with a titanium-platinum overcoat. The titanium-platinum acts as a catalyst. It is shown clearly that the layer of titanium-platinum 41 coats the surface of the pores with little titanium-platinum located in the aperture. This can be done by masking or otherwise. Both the cathode and anode are treated this way and both the pores in the cathode and anode are wide enough to let oxygen or hydrogen through. The pores of the anode can also be of the same size of the pores in the cathode and of a size to let input fuel through and are also coated with titanium-platinum. It is noted that the inside of the tubes are not coated with titanium-platinum and all this is described in the above-noted application.

If one refers to FIG. 4, there is shown the assembled fuel cell. As one can see, the anode structure designated by reference numeral 50 is located on the left, while the cathode structure, designated by reference numeral 51, is located on the right. The electrolytic structure 52 is in the center. The coated surface 54 of the anode 50 is secured to the left front surface of the electrolyte 52. While the coated surface 55 of the cathode is secured to the right side surface of the electrolyte 52. The surfaces can be secured by means of metallic bonds or other techniques. The input fuel shown on the left is, for example, hydrogen and is directed to the left side of the fuel cell, while oxygen or air is directed to the right side of the fuel cell. The fuel cell converts the hydrogen into hydrogen ions and electrons. The conversion allows the electrons from hydrogen to flow through the load 60 to thereby produce a current through the load, as is known. The platinum catalyst of the cell separates the hydrogen into ions which have a positive charge and electrons which are negatively charged. The hydrogen ions mate with the oxygen from the air and exit as water vapor or steam. The electrons are basically repelled by the cell and are collected to produce an electrical current to flow through the load 60.

As seen in FIG. 4, the fuel cell is made from three structures with the coated surface of the anode in contact with one face of the electrolyte structure 52 and a coated surface of the cathode structure is in contact with the other face of the electrolyte structure 52. This configuration is identical to the configuration shown in Kulite-71 or Ser. No. 10/085,387. The difference between the two structures is this application employs the use of nanostructures which make the fuel cell more efficient because of the unique properties of the nanostructures. As seen, electrical contact 61L and 61R are made to both the anode and cathode to permit electrons to leave the anode and later to re-enter the cathode.

The electrolyte structure 52 is filled with an ionic conductor such as phosphoric acid or any other convenient ionic conductor, which does not corrode the anode or cathode material. This is introduced by having the entire cell immersed in ionic conductor having a portion of the cell immersed. Most previous fuel cells use various organic materials for the anode, the cathode and the electrolytic structure. However, in this case the use of silicon carbide with nanostructures permits operation more efficiently and at a higher temperature due to its greater energy gap. Another advantage is that one can create large catalyst areas for both the anode and the cathode, due to the inclusion of the nanostructures on the surface of both substrates, this requiring a minimum volume of platinum.

As one can understand, while the fuel cell described operation with hydrogen, many potential fuels can be used which include the hydrocarbons, such as methane, ethane, acetylene, as well as compromise fuels, such as hydrazine, ammonia and methanol. All this is quite well-known. As one can ascertain, the cells can be extremely small and can be used to power cellular telephones, computers, or can be large or stacked in parallel for use in other applications, such as automobiles, appliances, etc.

It is understood that there are many alternative embodiments which can be envisioned by one skilled in the art. Basically, the major aspect of the present invention is to provide a method and apparatus for a fuel cell structure which can be fabricated from graphite or carbon nanotubes and is extremely easy to fabricate and extremely efficient in operation.

What is claimed is:

1. A solid state fuel cell, comprising:
a planar anode nanostructure of a given conductivity having a plurality of pores each of a given diameter directed from a first surface to a second surface, with said first surface coated with a metallic catalyst,
a planar cathode nanostructure of a given conductivity having a plurality of pores each of a predetermined diameter directed from a first surface to a second surface, with said first surface coated with a metallic catalyst,
an electrolyte planar structure having a plurality of pores directed from a first surface to a second surface, with said metallized surface of said anode structure coupled to said first surface of said electrolyte structure with said metallized surface of said cathode structure coupled to said second surface of said electrolyte structure.

2. The fuel cell according to claim 1 wherein said anode and cathode are fabricated from silicon and each is surrounded by a non-porous peripheral structure of a suitable material.

3. The fuel cell according to claim 1 wherein said electrolyte structure is fabricated from silicon.

4. The fuel cell wherein said pores of said anode and cathode are on the order of two nanometers in diameter.

5. The fuel cell according to claim 4 wherein said pores of said electrolyte are smaller than the pores of either said anode or cathode.

6. The fuel cell according to claim 4 wherein said electrolyte is fabricated from a low conductivity material as compared to the conductivity of said anode and cathode.

7. The fuel cell according to claim 1 wherein said metallic catalyst is platinum.

8. The fuel cell according to claim 1 wherein said metallic catalyst is titanium-platinum.

9. The fuel cell according to claim 1 wherein said metallized surface is to a depth of between 500 to 2000 Angstroms.

10. The fuel cell according to claim 1 wherein said second surface of said anode and cathode each has an electrical contact found thereon.

11. The fuel cell according to claim 4 wherein said pores of said electrolyte are filled with an ionic conductor.

12. The fuel cell according to claim 4 wherein said ionic conductor is phosphoric acid.

13. The fuel cell according to claim 1 wherein said anode pores are of a different diameter than said cathode pores.

14. The fuel cell according to claim 4 wherein said anode pores are of approximately the same diameter as said cathode pores.

15. The fuel cell according to claim 4 wherein said second surface of said anode is adapted to receive hydrogen gas.

16. The fuel cell according to claim 4 wherein said second surface of said cathode is adapted to receive oxygen.

17. The fuel cell according to claim 4 wherein said anode, cathode and electrolyte structures are fabricated from silicon.

18. The fuel cell according to claim 4 wherein said anode, cathode and electrolyte structures are fabricated from silicon carbide.

19. The fuel cell according to claim 16 wherein said fuel cell uses a hydrocarbon fuel such as methane, ethane, acetylene, butane and so on to provide hydrogen to said anode.

20. The fuel cell according to claim 1 wherein said anode is fabricated from silicon carbide.
